(19) United States
(12) Patent Application Publication
(10) Pub. No.: US 2018/0170297 A1
(43) Pub. Date: Jun. 21, 2018

(54) COLLISION DETECTION SENSOR

(71) Applicant: DENSO CORPORATION, Kariya-city (JP)

(72) Inventor: Makoto Sakai, Kariya-city (JP)

(21) Appl. No.: 15/837,993

(22) Filed: Dec. 11, 2017

(30) Foreign Application Priority Data
Dec. 16, 2016 (JP) 2016-244650

(51) Int. Cl. B60R 21/0132; H01R 31/00; H01R 13/66; G01P 15/08

(52) U.S. Cl. CPC B60R 21/0132; G01P 15/0802; H01R 13/6683; H01R 31/00

(57) ABSTRACT

A collision detection sensor configured as a two pin-type sensor and a four pin-type sensor. The two pin-type sensor having a first connection terminal, a second connection terminal and a switching terminal set to the first bus-return terminal. The first connection terminal provided with a first connection surface and a first lead pin extending from the first connection surface, and the second connection terminal provided with a second connection surface and a second lead pin extending form the second connection surface. The four pin type sensor having a third connection terminal in addition to the first and the second connection terminal, and the switching terminal set to the bus-out terminal. The third connection terminal provided with a third connection surface and two lead pins. The two pin-type sensor having the first and second lead pins and the four pin type-sensor having the first, second and two third lead pins.

### CROSS-REFERENCE RELATED APPLICATION

The application is based on and claims the benefit of the priority of earlier Japanese application No. 2016-244650, filed on Dec. 16, 2016, the description of which is incorporated herein by reference.

### BACKGROUND

The present disclosure relates to a collision detection sensor for a vehicle, in particular to a collision detection sensor which is applicable to an airbag system.

### RELATED ART

Airbag systems for vehicles, for example, protect vehicle occupants during a crash event such as a rollover or collision with an obstacle, such as a pole, or another vehicle. An airbag system provided with a collision detection sensor can detect when a vehicle collides with another vehicle or an obstacle, for example, and protects occupants in the vehicle by deployment of an airbag.

A collision detection sensor disclosed in JP2005-231523A is configured to detect acceleration of a vehicle, for example, in the respective forward, rear, left, right and vertical directions of the vehicle, and also a collision when a detected acceleration value is above a predetermined threshold.

Conventional collision detection sensors are configured by mounting a chip with an acceleration detection element onto a printed circuit board provided with a wiring pattern. There are collision detection sensors which have 2 terminals referred to as 2P connectors, and those with 4 terminals referred to as 4P connectors. A common chip is mounted to decrease a cost, therefore the printed circuit board wiring patterns are alternated according to a number of connection terminals.

Recently, there is an increased desire for further simplification of the collision detection sensor. A sensor module configured without using a printed circuit board, that is, a sensor module with a built-in chip having an acceleration detection element, which is directly connectable to a metal connection terminal can easily be conceived by a person skilled in the art. It is noted that a sensor is also referred to as G module hereinafter, in the specification of the present disclosure.

When the G module is configured without a printed circuit board, a G module that has a rectangular shaped top surface is also provided with each type of terminal on a bottom surface, which opposes a side of a connection terminal. Each terminal on the bottom surface connects to a corresponding connection terminal. However, although the terminal structure on the bottom surface of the G module is a common structure, a collision detection sensor may have a different number of connection terminals or different number of lead pins extending from the connection terminals to be connected to the G module.

Specifically, a standard communication protocol DSI3 (Distributed System Interface 3) is configured as a communication protocol for vehicle airbag systems. In order to provide DSI3 communication, the plurality of collision detection sensors are connected to an electric control unit used to control the airbag (which can also be referred to as an airbag ECU hereon in present disclosure). The plurality of sensors are serially connected by a daisy chain of bus terminals, whereby the voltage signals are transmitted from the airbag ECU to a sensor distributed nearest to the ECU, and then further transmitted to other serially disposed sensors. A response current signal is then transmitted to the airbag ECU, via bus-in and bus-return terminals which provide a connection between the plurality of collision detection sensors.

In this mode, for example, a first collision detection sensor is provided with three terminals, that is, bus-in, bus-out and bus-return, each of which is provided with a respective connection terminal. The first collision detection sensor is configured to transmit signals to a second collision detection sensor, which is disposed next to the first collision detection sensor. The connection terminals of the respective bus-in and bus-out terminals are each provided with one lead pin, and the connection terminal of the bus-return terminal is provided with two leads pins. The bus-return terminal has a first lead pin to transmit a response signal to the airbag ECU side, and a second lead pin into which a response signal may be transmitted to another sensor. In this case, a “four pin type” collision detection sensor provided with 4 lead pins is necessary for this situation.

In contrast, if the collision detection sensor is disposed at an end of a series of sensors, or there is only a single sensor connected to the airbag ECU, then it is unnecessary to provide a sensor which is further connectable to another collision detection sensor. In this case only there are only 2 connection terminals that connect to the respective bus-in and bus-return terminals, and one lead pin required for each terminal, thus “a two pin type” sensor having two lead pins is adequate.

In this way, different types of sensors, that is, two pin type and four pin type collision detection sensors are employed, for example, depending on the position or number of sensors. In addition to a common terminal structure provided on the bottom surface of the G module, previous attempts to construct a common connection terminal resulted in a position of the common connection terminal not being compatible with the desired terminal. It is therefore necessary to provide different types of G modules to facilitate the needs of the respective two point type and the four point type sensors.

In view of the above described issues, the present disclosure provides a collision detection sensor having a common G module terminal structure and a common connection terminal used to connect the common connection terminal to a desired terminal.

### SUMMARY

An aspect of the disclosure is a collision detection sensor provided with sensor module having a top surface, a bottom surface, and an acceleration detection element for detecting speed acceleration in a predetermined direction. The bottom surface of the sensor module has a bus-in terminal, a switchable terminal operable to switch to either one of a first bus-return terminal and a bus-out terminal, and a second bus-return terminal, which is different from the first bus-return terminal of the switching terminal. The collision detection sensor is configured as a two-pin type sensor provided with a first connection terminal having a first connection surface which connects to the bus-in terminal and a first lead pin extending from the first connection surface, a second connection terminal provided with a second connection surface which connects to the switching element and a second lead pin extending from the second connection surface, and the switching terminal set to the first bus-return terminal. The two pin-type sensor is provided with two lead pins being the first lead pin and the second lead pin.

The collision detection sensor is configured as a four-pin type sensor provided with a third connection terminal having a third connection surface which connects to the second bus-return terminal, and two third lead pins extending from the third connection surface, in addition to the first and the second connection terminals, the switching terminal set to the bus-out terminal. The four-pin type sensor is provided with four lead pins being the first lead pin, the second lead pin and two third lead pins.

According to the configuration described, the terminal connecting to the second connection terminal is the switching terminal which switches to either one of the first bus-return terminal and the bus-out terminal. That is, the second connection terminal is connected to either one of the bus-out and first bus-return terminals depending on the type of collision detection sensor. As a result, the sensor module according to the disclosure provides a common terminal structure in which the first, second and third connection terminals are connectable to a desired terminal, by using the first and second terminals.

### BRIEF DESCRIPTION OF THE DRAWINGS

In the accompanying drawings;

FIG. 1A is a descriptive block drawing showing a communication process of a collision detection sensor of an airbag system described in a first embodiment;

FIG. 1B is a functional block diagram showing an ECU of the airbag system;

FIG. 2A is perspective view of a four pin type collision detection sensor;

FIG. 2B is perspective view of a two pin type collision detection sensor;

FIG. 3 is a top surface layout showing a terminal structure of a G module provided on each of the collision detection sensors;

FIG. 4 is a block drawing illustrating a surrounding of the G module built-in circuit;

FIG. 5A is a top surface layout of the four pin type collision detection sensor; and

FIG. 5B is a top surface layout of the two pin type collision detection sensor.

### EMBODIMENTS

Embodiments of the disclosure will now be described with reference to the drawings. It is to be understood that a same symbol is used for elements and parts which are the same or equivalent thereto, in each of the embodiments.

### Preferred Embodiment

A first embodiment will now be described. A collision detection sensor used for an airbag system for a vehicle is described with reference to indicated figures.

The collision detection sensor used for an airbag system for a vehicle according to the first embodiment is an acceleration detector which is configured to detect acceleration generated in 3 axes, depending on a mounting direction of the collision detection sensor installed in a vehicle. More specifically, the collision detection sensor is equipped with an acceleration detection element, which can detect the acceleration in a respective front and rear, left and right, and up and down direction of the sensor. As long as detection in any of the directions can be performed, any type of the acceleration detection element may be applied to the detection collision sensor of the present disclosure.

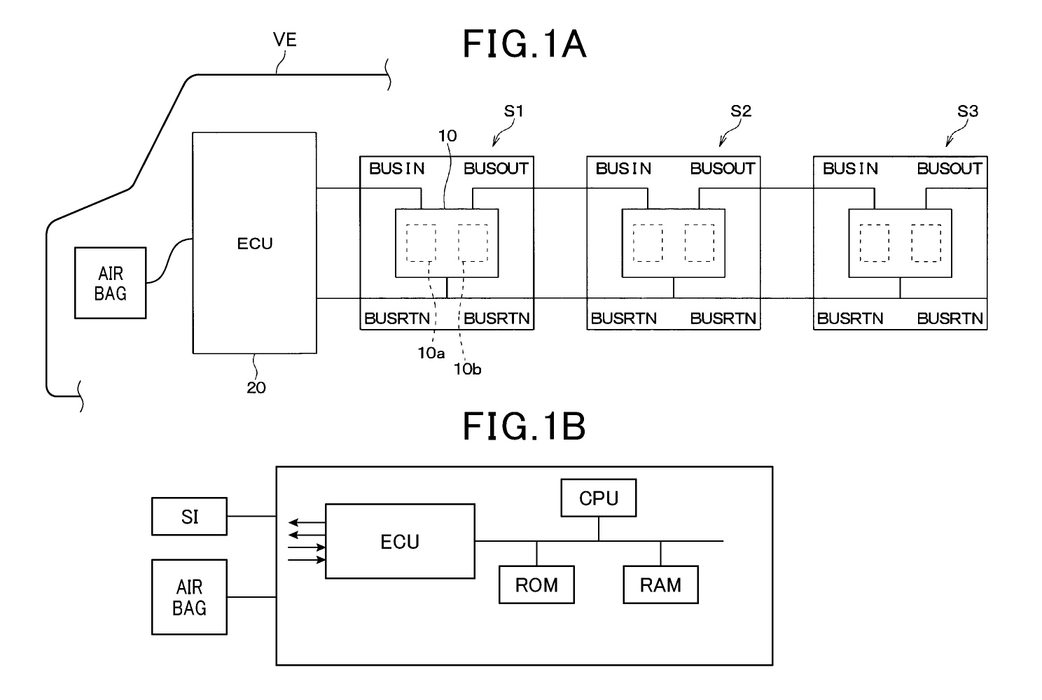

As shown in FIG. 1, DSI3 communication which is used in the airbag system for a vehicle is configured of a plurality of collision detection sensors S1 to S3, which are serially connected by a daisy chain of bus terminals, for a single airbag ECU20. As a result, signals between each collision detection sensor S1 to S3 are interchangeable. The collision detector sensors 1 to 3 are also simply referred to as sensors 1 to 3, for example, hereinafter.

The ECU is a computer system provided with a CPU20A (Central processing Unit), a ROM (Read Only Memory) 20B, and a RAM (Random Access Memory) 20C, as shown in FIG. 1B. The ECU is provided with the CPU20A performing a main control process, the ROM20B which stores predetermined programs and functions as a non-transitory storage media, and the RAM 20C. The CPU 20A actualizes each control unit by executing each program stored in the ROM20B. The RAM20C is a memory for temporary storage of data. The ECU is connected to the sensor S1 by BUS terminals described later in the specification. The DSI3 communication is configured with and actualized by a BUS-IN terminal (bus-in terminal), BUS-OUT terminal (bus-out terminal) and a BUS-RETURN terminal (bus-return terminal).

When collision detection is performed, for example, a pulse signal is input into a bus-in terminal of the sensor S1 (collision detection sensor S1) which is connected close to a side of the airbag ECU20, referred to as ECU20-side herein after, among the sensors S1 to S3. Next, a pulse is transmitted through a bus-out terminal of the sensor S1, to the bus-in terminal of the sensor 2 (collision detector sensor 2) which is the next sensor to the sensor S1.

In the same way, the bus-out terminal of sensor S2 transmits the signal to the bus-in terminal of the sensor S3 (third collision detection sensor S3). As shown in FIG. 1, the sensor 3 is a sensor disposed at an end of the daisy chain of bus terminals, for example. In this way, each of the respective collision detection sensors S1 to S3 output response signals which indicate a detected acceleration value at different timings, by a current, using the respective bus-in and bus-return terminals of the sensors S1 to S3. The airbag ECU20 is configured to determine whether the acceleration value has reached a level in which the airbag should be deployed, by the response signal transmitted to the airbag ECU20.

It is thus necessary for the sensors S1 and S2 to transmit signals to the respective sensors S2 and S3. More specifically, it is necessary the sensors S1 and S2, for example, to transmit signals to the next sensor which are the respective sensors S2 and S3. The sensors S1 and S2 are thus provided with the three terminals, bus-in (BUS-IN), bus-out (BUS-OUT) and bus-return (BUS-RTN) and the three connection terminals 1 to 3 which connect to a corresponding terminal. The connection terminals of the bus-in and bus-out terminals are each provided with one lead pin, whereas, the bus-return terminal is provided with two lead pins. The bus-return terminal is provided with a first lead pin which transmits the response signal to the airbag ECU-side and a second lead pin to which the response signal is transmitted, from the bus-return terminal of a sensor adjacent thereto. The sensors 1 and 2 are thus provided as four pin type sensors, equipped with four lead pins.

In contrast, when the sensor S3 is disposed at one end of the three sensors, or provided as a single collision detection sensor for an airbag ECU, it is unnecessary to facilitate a further connection for another sensor. In such cases, a total of two connection terminals for connection of the respective bus-in and bus-return terminals are necessary, thus only one lead pin is required for each of the bus-in and bus-return terminals. The sensor 3 is thus provided as a two pin type sensor equipped with two lead pins.

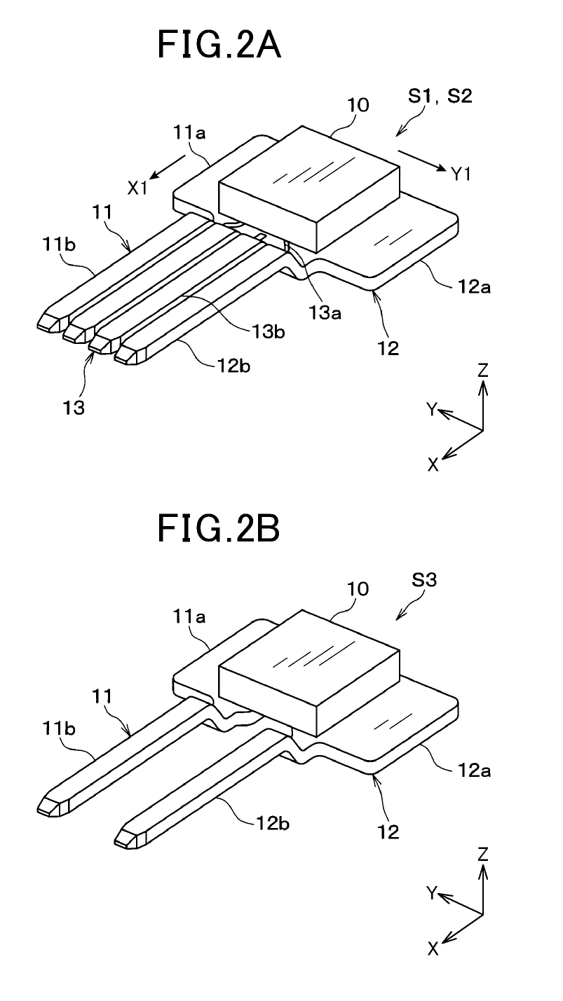

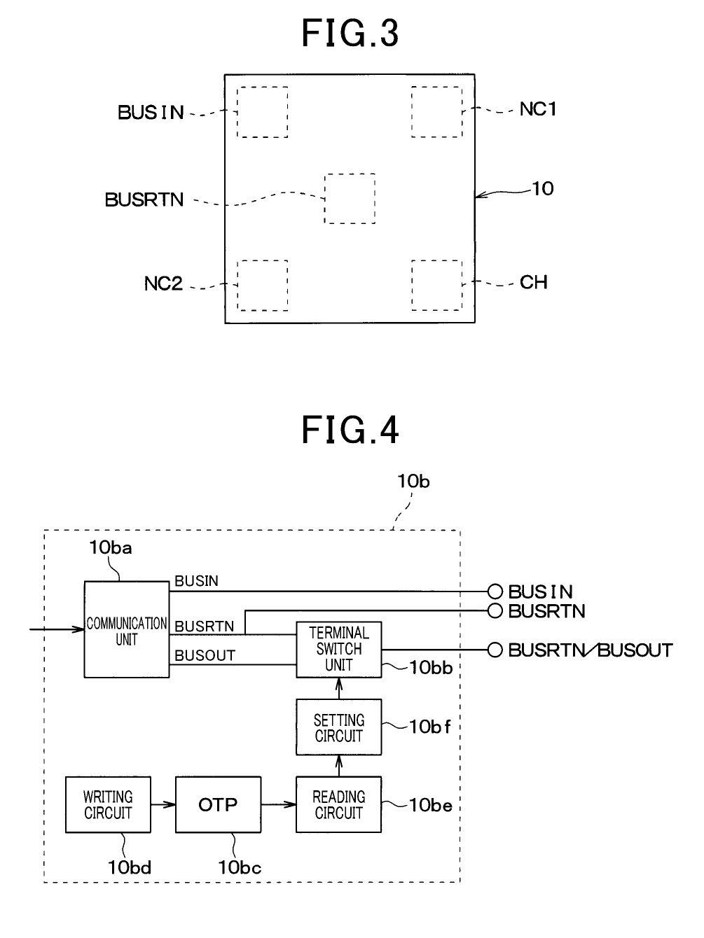

FIG. 2A is a perspective view of the four pin type sensors S1 and S2, and FIG. 2B is a perspective view of the two pin type sensor S3. As shown in FIGS. 2A and 2B, each of the sensors S1 to S3 are configured with a G module 10 (an accelerometer) having an acceleration detection element.

Each of the sensors S1 to S3 are provided with a common G module 10 configured as a cubic shape with a rectangular top surface. With reference to FIG. 1, each G module 10 has a built in chip, which includes an acceleration detection element 10a for detecting the acceleration of the vehicle in a predetermined direction. The sensors S1 and S2 are equipped with the acceleration detection element 10a which detects the acceleration in a direction parallel to a top surface of the G module 10. For example, the sensors S1 and S2 are sensors used to detect an acceleration in the respective X and Y axial directions of the vehicle, when the X axial direction is defined as a front and rear direction, and the Y axial direction is defined as a left and right direction of the vehicle in which the sensors S1 to S2 are mounted.

In FIGS. 2 A and 2B the top surface of the G module 10 has one pair of sides parallel to an X1 axial direction which is a longitudinal direction of the sensor, and a second pair of sides parallel to an Y1 axial direction which is a lateral direction of the sensor. Incidentally, the X1 and Y1 axial directions are coincident with the respective X and Y axial directions. For example, the X1 axial direction of the sensor is parallel to the X axial direction, thus the sensor is positioned to detect the acceleration of the vehicle in the front and rear direction thereof.

The sensor S3 is equipped with the acceleration detection element 10a configured to detect the acceleration of the vehicle in a direction perpendicular to the top surface of the G module 10. For example, the sensor S3 is used to detect acceleration in a Z axial direction, when the Z axial direction is defined as a vertical direction of the vehicle in which the sensor S2 is mounted.

The G module 10 is equipped with a peripheral circuit 10b in addition to the acceleration detection element 10a. The peripheral circuit 10b includes a signal processing circuit, for example, for processing output signals from the acceleration detection element 10a, as shown in FIGS. 1 and 4. Since the G module 10 is equipped with the peripheral circuit 10b, the G module 10 is known as a System in Package or SiP.

As shown in FIG. 4, the peripheral circuit 10b is provided with a communication unit 10ba, a terminal switch unit 10bb, a one-time programmable memory (referred to as OTP hereon) 10bc, a writing circuit 10bd, a reading circuit 10be, and a setting circuit 10bf, for example.

The communication unit 10ba inputs signals from the airbag ECU20 via the bus-in terminal, transmits signals to the next G module 10 via the bus-out terminal, and transmits a result of a detected acceleration value via the bus-in and bus-return terminals.

The terminal switch unit 10bb is connected to lead wirings which are connected to the respective bus-return and the bus-out terminals of the communication unit 10ba. The terminal switch unit 10bb switches a connection to connect of either one of the terminals to the switching terminal CH. The switching terminal CH is set to the bus-return terminal when the lead wiring which connects the bus-return terminal of the communication unit 10ba is selected. In the same way, the switching terminal CH is set to the bus-out terminal when the lead wiring connecting the bus-out terminal is selected. The terminal switch unit 10bb thus switches a connection to either one of the bus-return and the bus-out terminals, according to the selected terminal.

The OTP 10bc is a switch setting unit configured to switch a route of the peripheral circuit 10b. According to the preferred embodiment, the OTP 10bc has an initial value set so that the terminal switch unit 10bb is switched to the bus-return terminal before writing is performed. Once writing to the OTP 10bc is completed, the connection is switched by the terminal switch unit 10bb, according to a content of the OTP 10bc.

The writing circuit 10bd is a circuit provided to perform writing to the OTP 10bc. The writing circuit 10bd writes the content to the OTP 10bc, when communication for the writing is performed. It is to be understood that communication for writing is also referred to as writing communication hereon in the specification of the present disclosure. Communication to the writing circuit 10bd may be actualized by a positive electrode terminal in which a positive electrode may be applied to the peripheral circuit 10b and an earth GND terminal. In the preferred embodiment, writing communication is performed by the bus-in terminal for the positive terminal and the bus-return terminal as the GND terminal. This is described in further detail later in the specification.

The reading circuit 10be reads the content written to the OTP 10bc, and transmits the content to the setting circuit 10bf.

The setting circuit 10bf switches the setting of the terminal switch unit 10bb on the basis of the content read at the reading circuit 10be. In this way, the terminal switch unit 10bb is set by switching according to the content written to the OTP 10bc.

The G module 10 provided with the rectangular shaped top surface, has one set of opposing sides parallel to each other and a second set of the opposing sides positioned in a perpendicular direction to the first set of sides. Additionally, on a rectangular shaped bottom surface of the G module 10, there are four corners among which the bus-in (BUS-IN) terminal is positioned on a first corner and the switching terminal CH is opposed on a second corner diagonally opposed to the first corner. The switching terminal CH is switchable to both the bus-out (BUS-OUT) and bus-return (BUS-RTN) terminals. Switching to either one of the bus-out and bus-return terminals at the switching terminal CH is determined on the basis of the content written on the OTP 10bc.

Additionally, a first non-connection terminal NC1 and a second non-connection terminal NC2 are provided on a respective third and fourth corner diagonally opposed to each other on the bottom surface of the G module 10. The first and second non-connection terminals NC1 and NC2, also simply referred to as terminal NC1 and terminal NC2 hereon, are terminals which are not-electrically connected to the acceleration detection element and the signal process circuit, and may also be referred to as dummy terminals. The terminals NC1 and NC2 are formed to enhance stable connection when connecting, by welding for example, and not necessarily considered as essential terminals. For example, the terminals bus-in and bus-out are connected respectively to the connection terminals 11 and 12. However, the G module 10 may be tilted and a stable connection may be difficult to achieve when only the bus-in and bus-out terminals are provided. In this regard, by providing the NC1 and NC2 terminals, the G module 10 may be supported at more points of the module and stable connection of the connection terminals achieved as a result.

Additionally, the bus-return terminal is provided in a center part of the bottom surface of the G module 10 surrounded by the bus-in terminal, switch terminal CH, the first NC1 and the second NC2 provided on each corner thereof.

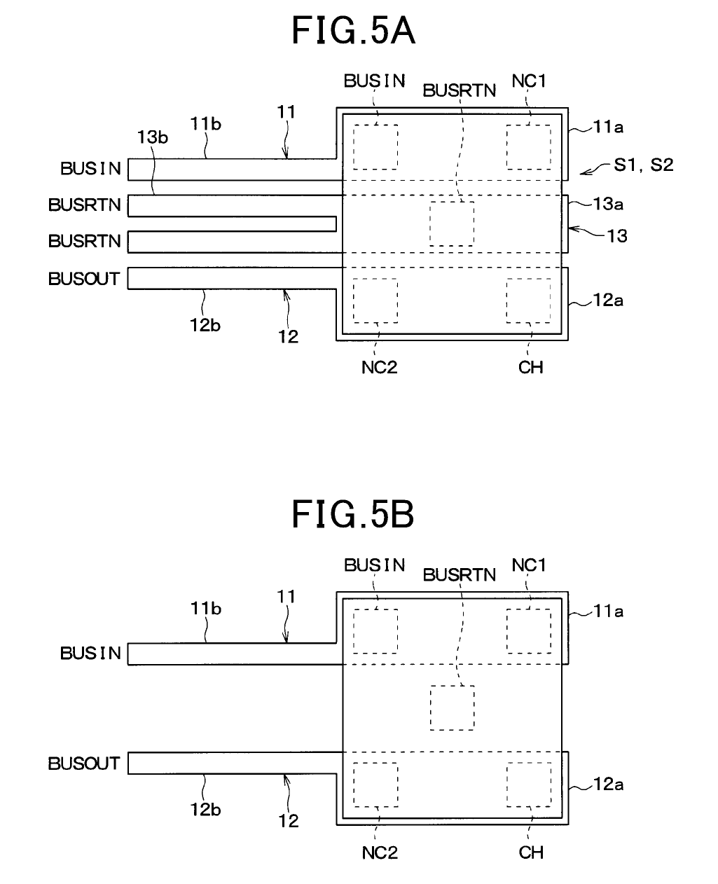

FIGS. 5A and 5B exemplify the sensors S1 to S3, explicitly showing the four pin-type sensors S1 and S2 and the two pin type sensor S3 each provided with the G-modules 10. The FIG. 5A shows the sensors S1 and S2 having the connection terminals 11 to 13 connected to each terminal of the G module 10. The FIG. 5B shows the sensor S3 having the connection terminals 11 and 12 connected to each terminal of G module 10. The connection terminals 11 and 12 provided on sensors S1 and S2 are configured in the same way as the connection terminals 11 and 12 provided on the sensor S3, that is, the connection terminals 11 and 12 are provided with a common structure for all three sensors S1 to S3.

The connection terminal 11 in FIGS. 5A and 5B represents a first connection terminal 11 provided with a connection surface 11a and one lead pin 11b which is projected from the connection surface 11a in a one way direction. The connection surface 11a is a flat surface in which the G module 10 is connected thereto. In the same way, the connection terminal 12 represents a second terminal which is also provided with the connection surface 12a configured as a flat surface in which the G module 10 is connected thereto, and one lead pin 12b which is projected from the connection surface 12a in a one way direction. The connection terminals 11 and 12 are each provided with one respective lead pin 11b and 12b. The connection surfaces 11a and 12a provided on the respective connection terminals 11 and 12, are cuboid shaped with a length which is longer than a length of a longest side of the G module 10 in an X1 axial direction of the sensor. Each of the connection terminals 11 and 12 have the respective pin leads 11b and 12b disposed with a predetermined space there between, each projected towards the same direction thereof.

In FIG. 5A, the connection terminal 13 which represents a third terminal, is provided with a cubic shaped connection surface 13a configured as a flat surface which connects to the G module 10 and the lead pin 13b extending from a first end of the connection surface 13a. The connection terminal 13 is provided with two lead pins 13b configured to extend parallel to each other from the first end of the connection surface 13a. The connection terminal 13 is disposed between the connection terminals 11 and 12, configured with the two lead pins 13b provided to extend in the same direction as the lead pins 11b and 12b.

As shown in FIG. 5A, the sensors S1 and S2 are 4 pin type sensors. The four pin type sensors are configured with terminal connectors 11 to 13 each of which is provided with the respective lead pins 11b to 13b. In contrast, the sensor S3 is a 2 pin-type sensor, configured with the terminal connectors 11 and 12 each provided with the respective lead pins 11b and 12b, as shown in FIG. 5B.

In the configuration described, the sensors S1 and S2 are configured with the terminals arranged desirably in an order of the bus-in, bus-return and bus-out, as shown in FIG. 5A. The sensors S1 and S2 are the four pin-type sensors provided with the connection terminals 11 to 13 having the respective lead pin 11b to 13b. The connection terminals 11 to 13 each connect to a corresponding terminal according to the number of lead pins, when the terminals are arranged in the order described above.

As shown in FIG. 5A, the connection terminal 11 has one lead pin 11b which connects to the bus-in terminal (BUS-IN), the connection terminal 13 has two lead pins 13b which connect to the bus-return terminals (BUS-RTN), and the connection terminal 12 has one lead pin 12b which connects to the bus-out terminal (BUS-OUT). In this way, the switching terminal CH which connects to the connection terminal 12 is switched to the bus-out terminal based on writing to the OTP 10bc.

In contrast, the sensor S3 is configured with the terminals arranged desirably in an order of the bus-in (BUS-IN) and bus-return (BUS-RTN). The sensor S3 is the two pin-type sensor, provided with connection terminals 11 and 12 each having the respective lead pin 11b and 12b which connect to the corresponding terminal provided in the order described above. The two pin-type sensor is provided with only two lead pins 11b and 12b, thus will not use the connection terminal 13. In the configuration described, the connection terminal 11 having one lead pin 11b is connected to the bus-in terminal, and the connection terminal 12 having one lead pin 12b which is the remaining lead pin connected to the bus-return terminal. The switching terminal CH which is connected to the connection terminal 12 is thus set to the bus-return terminal based on the content written on the OTP 10bc.

In this way, the terminal which connects to the connection terminal 12 is the bus-out (BUS-OUT) terminal for the sensors S1 and S2, and the bus-return (BUS-RTN) terminal for the sensor S3. As a result, the connection terminal 12 is connected to the switching terminal CH, which switches the bus-out and bus-return terminals. The sensors S1 and S2 are configured to switch to the bus-out terminal and the sensor S3 is configured to switch to the bus-return terminal, by switching of the switching terminal CH.

As a result, in addition to providing the G module 10 with a common structure, the common connection terminals 11 and 12 may be connected to the desired terminal.

Next, a switching procedure of the switching terminal CH will be described for the sensors S1 to S3, according to the preferred embodiment, with reference to a block diagram shown in FIG. 4.

The switching to either one of the bus-out and bus-return terminals by the switching terminal CH is performed based on writing to the OTP 10bc which is configured to switch a route of the peripheral circuit, on the basis of the content of the writing. That is, the OTP 10bc operates settings of the terminal switch unit 10bb which determines which terminal is connected to the switching terminal CH. That is, which of the bus-out and bus-return terminals is connected to the switching terminal CH by the terminal switch unit 10bb. The writing to the OTP 10bc is performed by the writing circuit 10bd on the basis of communication for the writing. After writing to the OTP 10bc is performed, the written content is read at the reading circuit 10be, and the route switching of the terminal switch unit 10bb performed via the setting circuit 10bf. As a result, either one of the selected bus-out and bus-return terminals of the communication unit 10ba is connected to the switching terminal CH.

The switching terminal CH is thus performed on the basis of the writing communication for the G module 10. The writing to the OTP 10bc is performed by writing communication on the current route which has the bus-in terminal set as positive terminal and the bus-return as negative terminal, for example.

It is also possible to perform writing to the OTP 10bc before the G module 10 is connected to the connection terminals 11 to 13, however, more preferable to connect the connection terminals 11 to 13 to the G module 10 before writing is performed, as the connection terminals may then be used to write to the OTP 10bc and thus simplification of a writing process may be achieved. In this case, writing to the OTP 10bc may be actualized on the basis of airbag ECU 20 communication, for example, and further simplification of the writing process obtained as a result. In order to implement the configuration described above, it is however necessary to provide a mode in which communication is performed by a current route in which the bus-in and bus-return terminals are used for the respective plus and minus terminals.

The initial value of the OTP 10bc is thus set so that the switching terminal CH is switched to the bus-return terminal to facilitate the 2 pin-type sensor S3 with a path of the current path passing through the bus-return terminal. According to the configuration described, the connection terminal 12 is connected to the switching terminal CH which is switched to the bus-return terminal, before writing to the OTP 10bc is performed. As a result, communication for writing can be achieved from the connection terminal 11 through the bus-in terminal, and from the switching terminal CH set to the bus-return terminal through the connection terminal 12, for the 2 pin type sensor S3. Furthermore, writing to the OTP 10bc can be performed, for example, after the series of collision detection sensors S1 to S3 are installed in the vehicle.

### Other Embodiments

It is to be understood that the present disclosure is not limited to the preferred embodiment described herein above, and modifications may be introduced without departing from the essence of the claims.

As an example, in the preferred embodiment the G module 10 is configured with the non-connection terminals NC1 and NC2 provided on the bottom surface, however the G module 10 may be configured without the NC1 and NC2 terminals. The disposed position of the bus-in and bus-return terminals and the switching terminal CH is also optional and may be changed to a different position, as long as the terminals are arranged in the specific order of bus-in, bus-return and the switching terminal CH. For example, the bus-in terminal and switching terminal CH are positioned diagonally to each other on two corners of the four cornered rectangular shaped G module 10, however not limited to such an arrangement. That is, a same effect may obtained when using the connection terminals 11 to 13, as long as the terminals are arranged in the specific order of bus-in, bus-return and the switching terminal CH along a side which is optionally chosen among the sides of the rectangular shape G module.

In another example, the G module 10 is not essentially provided with the square shape top surface and may be configured as a different rectangular shape or round cornered rectangular shape for example. The shape of the connection terminals 11 to 13 described in the preferred embodiment is only one example and the connection terminals may be configured in a different shape. For example, the lead pins 11b to 13b are not limited to projecting in a straight line, and may also project with a curved section provided therein.

The collision detection sensors S1 to S3 configured of the G module 10 and the connection terminals 11 to 13 is exemplified in the preferred embodiment, however, other configuring elements may also be included in the configuration. That is, the sensors S1 to S3 may be configured with a sealing resin which covers the G module 10 and the connection surfaces 11a to 13a, and only a tip end of the lead members 11b to 13b exposed.

### REFERENCE SIGN LIST

10 . . . G module
10bb . . . terminal switch unit
10bc . . . OTP
11, 12, 13 . . . connection terminal
11a, 12a, 13a . . . connection surface
11b, 12b, 13b . . . lead pin
BUS-IN . . . bus-in terminal
BUS-OUT . . . bus-out terminal
BUS-RETURN . . . bus-return terminal
CH . . . switching terminal

What is claimed is:

1. A collision detection sensor comprising:
a sensor module provided with a top surface, a bottom surface, and an acceleration detection element for detecting speed acceleration in a predetermined direction;
the bottom surface of the sensor module having a bus-in terminal, a switching terminal operable to switch to either one of a first bus-return terminal and a bus-out terminal, and a second bus-return terminal which is different to the first bus-return terminal of the switching terminal, wherein,
the collision detection sensor is a configured as a two pin type sensor provided with
a first connection terminal having a first connection surface and a first lead pin extending from the first connection surface;
a second connection terminal having a second connection surface and a second lead pin extending from the second connection surface;
the switching terminal set to the first bus-return terminal, and
the first lead pin and the second lead pin to configure two lead pins, and
the collision detection sensor is configured as a four pin type sensor provided with
a third connection terminal having a third connection surface which connects to the second bus-return terminal and two third lead pins extending from the third connection surface; in addition to the first and second connection terminals,
the switching terminal set to the bus-out terminal, and
the first lead pin, the second lead pin and the two third lead pins to configure four lead pins.

2. A collision detection sensor comprising:
a sensor module provided with a top surface, a bottom surface, and an acceleration detection element for detecting acceleration in a predetermined direction;
the bottom surface of the sensor module provided with a bus-in terminal, a switching terminal operable to switch to either one of a first bus-return terminal and a bus-out terminal, and a second bus-return terminal which is a different to the first bus-return terminal of the switching terminal,
a first terminal having a first connection surface and a first lead pin extending from the first connection surface; and
a second connection terminal having a second connection surface and a second lead pin extending from the second connection surface, wherein,
the collision detection sensor is a two pin-type sensor provided with the switching terminal set to the first bus-return terminal and the first lead pin and the second lead pin to configure two lead pins.

3. A collision detection sensor comprising:
a sensor module provided with a top surface, a bottom surface, and an acceleration detection element for detecting speed acceleration in a predetermined direction;
the bottom surface of the sensor module provided with a bus-in terminal; a switching terminal operable to switch to either one of a first bus-return terminal and a bus-out terminal; and a second bus-return terminal which is a different to the first bus-return terminal of the switching terminal,
a first connection terminal having a first connection surface and a first lead pin extending from the first connection surface;
a second connection terminal having a second connection surface and a second lead pin extending from the second connection surface; and
a third connection terminal having a third connection surface which connects to the second bus-return terminal, wherein,
the collision detection sensor is a four pin-type sensor provided with the switching terminal switched to the bus-out terminal, and four lead pins being the first lead pin, the second pin and two third lead pins.

4. The collision detection sensor according to claim 1, wherein,
the sensor module comprises a switch setting unit configured to switch the switching terminal to either one of the first bus-return terminal and the bus-out terminal.

5. The collision detection sensor according to claim 4, wherein,
the switch setting unit is initially set so that the switching terminal is set to the first bus-return terminal.

6. The collision detection sensor according to claim 1, wherein,
the sensor module is configured as cuboid shape having a rectangular shape top surface, and the bus-in terminal, the second bus-return terminal and the switching terminal arranged in a respective order of the bus-in terminal, the second bus-return terminal and the switching terminal, each disposed along a side optionally chosen among sides of the rectangular shape surface.

7. The collision detection sensor according to claim 1, wherein,
the sensor module is configured as cuboid shape provided with a rectangular shape top surface and the bottom surface which has four corners, the bus-in terminal being disposed on a first corner and the switching terminal disposed on a second corner among the four corners of the bottom surface, so that the bus-in terminal and the switching terminal diagonally oppose each other.

8. The collision detection sensor according to claim 7, wherein the rectangular shape has a center part and the second bus-return terminal disposed in the center part.

9. The collision detection sensor according to claim 2, wherein,
the sensor module comprises a switch setting unit configured to switch the switching terminal to either one of the first bus-return terminal and the bus-out terminal.

10. The collision detection sensor according to claim 3, wherein,
the sensor module comprises a switch setting unit configured to switch the switching terminal to either one of the first bus-return terminal and the bus-out terminal.

11. The collision detection sensor according to claim 2, wherein,
the sensor module is configured as cuboid shape having a rectangular shape top surface, and the bus-in terminal, the second bus-return terminal and the switching terminal, arranged in a respective order of the bus-in terminal, the second bus-return terminal and the switching terminal each disposed along a side optionally chosen among sides of the rectangular shape surface.

12. The collision detection sensor according to claim 3, wherein,
the sensor module is configured as cuboid shape having a rectangular shape top surface, and the bus-in terminal, the second bus-return terminal and the switching terminal, arranged in a respective order of the bus-in terminal, the second bus-return terminal and the switching terminal each disposed along a side optionally chosen among sides of the rectangular shape surface.

13. The collision detection sensor according to claim 4, wherein,
the sensor module is configured as cuboid shape having a rectangular shape top surface, and the bus-in terminal, the second bus-return terminal and the switching terminal, arranged in a respective order of the bus-in terminal, the second bus-return terminal and the switching terminal each disposed along a side optionally chosen among sides of the rectangular shape surface.

14. The collision detection sensor according to claim 5, wherein,
the sensor module is configured as cuboid shape having a rectangular shape top surface, and the bus-in terminal, the second bus-return terminal and the switching terminal, arranged in a respective order of the bus-in terminal, the second bus-return terminal and the switching terminal each disposed along a side optionally chosen among sides of the rectangular shape surface.

15. The collision detection sensor according to claim 2, wherein,
the sensor module is configured as cuboid shape provided with a rectangular shape top surface and the bottom surface which has four corners, the bus-in terminal being disposed on a first corner and the switching terminal disposed on a second corner among the four corners of the bottom surface, so that the bus-in terminal and the switching terminal diagonally oppose each other.

16. The collision detection sensor according to claim 3, wherein,
the sensor module is configured as cuboid shape provided with a rectangular shape top surface and the bottom surface which has four corners, the bus-in terminal being disposed on a first corner and the switching terminal disposed on a second corner among the four corners of the bottom surface, so that the bus-in terminal and the switching terminal diagonally oppose each other.

17. The collision detection sensor according to claim 4, wherein,
the sensor module is configured as cuboid shape provided with a rectangular shape top surface and the bottom surface which has four corners, the bus-in terminal being disposed on a first corner and the switching terminal disposed on a second corner among the four corners of the bottom surface, so that the bus-in terminal and the switching terminal diagonally oppose each other.

18. The collision detection sensor according to claim 5, wherein,
the sensor module is configured as cuboid shape provided with a rectangular shape top surface and the bottom surface which has four corners, the bus-in terminal being disposed on a first corner and the switching terminal disposed on a second corner among the four corners of the bottom surface, so that the bus-in terminal and the switching terminal diagonally oppose each other.
